(19) United States
(12) Patent Application Publication
(10) Pub. No.: US 2016/0364670 A1
(43) Pub. Date: Dec. 15, 2016

(54) ASSEMBLY SYSTEM CONFIGURATION

(71) Applicants: GM GLOBAL TECHNOLOGY OPERATIONS LLC, Detroit, MI (US); The Regents of the University of Michigan, Ann Arbor, MI (US)

(72) Inventors: Yhu-Tin Lin, Rochester Hills, MI (US); Raymond D. Turner, III, Canadensis, PA (US); Jeffrey A. Abell, Rochester Hills, MI (US); Daniel J. Casoli, Howell, MI (US); Patrick J. Meehan, Ann Arbor, MI (US); Shixin Hu, Ann Arbor, MI (US); Hui Wang, Tallahassee, FL (US); Sheng Yang, Ann Arbor, MI (US); Heng Kuang, Ann Arbor, MI (US)

(73) Assignees: The Regents of the University of Michigan, Ann Arbor, MI (US); GM GLOBAL TECHNOLOGY OPERATIONS LLC, Detroit, MI (US)

(21) Appl. No.: 14/735,647

(22) Filed: Jun. 10, 2015

(51) Int. Cl. G06Q 10/06; G06Q 10/08

(52) U.S. Cl. CPC G06Q 10/06316; G06Q 10/0633; G06Q 10/0875

(57) ABSTRACT

A method for generating a candidate assembly system layout for an assembled product includes inputting a bill of materials including a list of components for the assembled product and determining a plurality of assembly patterns for the assembled product including a plurality of intermediate assemblies and sub-assemblies. A basic task layout is determined that includes assembly tasks for assembling the assembled product based upon a selected one of the assembly patterns. A whole task layout is determined based upon the basic task layout for the selected assembly pattern. Candidate assembly machines are selected for the whole task layout, and zoning constraints are identified for the candidate assembly machines related to assembly tasks. A candidate assembly system layout is generated based upon the whole task layout, the selected candidate assembly machines and the zoning constraints, from which a simulation model of a candidate assembly system is generated.

### STATEMENT REGARDING FEDERALLY-SPONSORED RESEARCH OR DEVELOPMENT

This invention was made with Government support under DE-EE-0002217, awarded by the U.S. Department of Energy. The United States Government has certain rights in this invention.

### TECHNICAL FIELD

The disclosure relates to developing and evaluating assembly system configurations.

### BACKGROUND

Developing candidate assembly system configurations is a repetitively complex and time consuming process that may be necessary for initial production planning, supplier proposal evaluation and final system optimization. One method includes manual system modeling and simulation, which may require high skill levels and an abundance of time to satisfactorily explore options. Designers have been known to resort to pattern matching with past experience and simplified spreadsheet estimation, which often result in significant budget over- or under-estimation and non-optimal best-fit system selection or design. Parameters taken into consideration by designers in planning an assembly system configuration include cycle time, scrap rate and production targets related to processing time, cost and productivity.

### SUMMARY

A method for generating a candidate assembly system layout for an assembled product is described, and includes inputting a bill of materials including a list of components for the assembled product and determining a plurality of assembly patterns for the assembled product including a plurality of intermediate assemblies and sub-assemblies. A basic task layout is determined that includes assembly tasks for assembling the assembled product based upon a selected one of the assembly patterns. A whole task layout is determined based upon the basic task layout for the selected assembly pattern. Candidate assembly machines are selected for the whole task layout, and zoning constraints are identified for the candidate assembly machines related to assembly tasks. A candidate assembly system layout is generated based upon the whole task layout, the selected candidate assembly machines and the zoning constraints, and a simulation model of a candidate assembly system is generated based upon the candidate assembly system layout. A simulation of the candidate assembly system is executed to evaluate cycle times and throughput to achieve the assembled product based upon the simulation model of the candidate assembly system.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically shows a routine that includes a plurality of discrete, preferably ordered steps for identifying and evaluating candidate assembly systems for producing an assembled product, in accordance with the disclosure;

FIG. 2-1 pictorially shows a first start menu screen for a process for producing an assembled product, in accordance with the disclosure;

FIG. 2-2 pictorially shows a second start menu screen for a process for producing an assembled product, in accordance with the disclosure;

FIG. 3 pictorially shows an embodiment of a bill of materials input screen that enables a user to input a bill of materials for an assembled product for use in generating candidate assembly system layouts, in accordance with the disclosure;

FIG. 4 pictorially shows an embodiment of an assembly pattern input screen that enables a user to input assembly patterns, which are intermediate assemblies or sub-assemblies of the assembled product, in accordance with the disclosure;

FIG. 5 pictorially shows an embodiment of a basic task layout selection screen, including a screen window showing a plurality of candidate assembly task layouts for an example assembly pattern arranged in menu form, in accordance with the disclosure;

FIG. 6 pictorially shows an embodiment of a selected single candidate whole task layout screen, i.e., a candidate assembly system layout to produce an assembled product, in accordance with the disclosure;

FIG. 7 pictorially shows an embodiment of an assembly machine database screen for identifying a plurality of assembly machines, in accordance with the disclosure;

FIG. 8 pictorially shows an embodiment of an assembly machine selection screen for selecting candidate assembly machines including a menu with a plurality of assembly machine types and tasks, in accordance with the disclosure;

FIG. 9 pictorially shows an embodiment of a spreadsheet screen that indicates tasks, candidate machines, cycle times and costs for a plurality of identified tasks, in accordance with the disclosure;

FIGS. 10-1 and 10-2 pictorially show embodiments of zoning constraints screens including a first screen showing constraints that restrict assembly tasks to a single assembly machine and a second screen showing constraints that require certain assembly tasks be performed on separate machines, in accordance with the disclosure;

FIG. 11 pictorially shows a block diagram of a portion of candidate assembly system layout, in accordance with the disclosure;

FIG. 12 pictorially shows a screen including a portion of a pictorial representation of a simulation model of a candidate assembly system associated with one of the candidate whole task layouts, in accordance with the disclosure;

FIG. 13 pictorially shows a basic machine worksheet for providing user input to a simulator that is associated with the simulation model of the candidate assembly system, in accordance with the disclosure;

FIG. 14 pictorially shows an example of a multi-cycle machine input worksheet for simulation of one of the multi-cycle machines engaged in repetitive assembly of parts, in accordance with the disclosure;

FIG. 15 pictorially shows an example of a multi-task machine input worksheet for simulation of one of the multi-task machines engaged in repetitive assembly of parts, in accordance with the disclosure;

FIG. 16 pictorially shows an example of a multi-task assembly machine input worksheet for simulation of one of the multi-task assembly machines engaged in repetitive assembly of parts, in accordance with the disclosure;

FIG. 17 pictorially shows an example of a buffer worksheet for simulation of one of the buffers engaged in the candidate assembly system, in accordance with the disclosure;

FIG. 18 pictorially shows an example of a conveyor worksheet for simulation of one of the conveyors engaged in the candidate assembly system, in accordance with the disclosure;

FIG. 19 pictorially shows an example of a control logic selection worksheet for selecting one of an input or output control logic, e.g., for selecting a mechanism for handling part scrapping and machine replenishment for simulation of the candidate assembly system, in accordance with the disclosure;

FIG. 20 schematically shows a direct replenishment control routine for controlling a multi-task assembly machine, in accordance with the disclosure;

FIG. 21 schematically shows a tagged replenishment control routine for controlling a multi-task assembly machine, in accordance with the disclosure;

FIG. 22 pictorially shows an example of an output worksheet screen that is output from the simulator that is associated with the simulation model of the candidate assembly system associated with one of the candidate whole task layouts, in accordance with the disclosure; and

FIG. 23 schematically shows a simulation process overview for gathering information to generate candidate assembly system configurations that may be subjected to process simulation for evaluation in conjunction with system requirements and constraints, in accordance with the disclosure.

### DETAILED DESCRIPTION

Referring to the drawings, wherein like numerals indicate like or corresponding parts throughout the several views, a method and associated system for generating, selecting, optimizing and simulating candidate assembly system configurations is described, which includes identifying and evaluating candidate assembly system layouts in conjunction with system requirements and constraints. A plurality of candidate task and system layouts are automatically generated by computational algorithms based upon inputs of a bill of materials and a plurality of preferred assembly patterns. One of the candidate system layouts may be selected and optimized to best satisfy an objective function in terms of cost and productivity, including selecting preferred machines and associated machine restrictions (zoning). The assembly machines in the selected assembly system layout may be one of a single task machine, a multi-cycle machine, a multi-task machine and a multi-task assembly machine. The assembly system layout is further evaluated through discrete simulation that takes into account production scrapping, part replenishment and assembly task allocations. Candidate assembly system configurations are thus identified and evaluated in conjunction with system requirements and constraints. One of the candidate system layouts that satisfies an objective function in terms of cost, productivity and/or quality may be selected as a preferred system layout for implementation. The method is reduced to practice as a flexible, fast processing and easy-to-use math-based tool for high level planning and configuration of assembly systems.

The method for generating a candidate assembly system layout for an assembled product includes inputting a bill of materials including a list of components for the assembled product and determining a plurality of assembly patterns for the assembled product including a plurality of intermediate assemblies and sub-assemblies. A basic task layout is determined that includes assembly tasks for assembling the assembled product based upon a selected set of the assembly patterns. The basic task layout can be added with nonstandard assembly tasks, such as inspection and electric tests, to complete a whole task layout Candidate assembly machines are selected for the whole task layout, and zoning constraints are identified for the candidate assembly machines related to the assembly tasks, whether standard or nonstandard. A candidate assembly system layout is computationally generated by optimization algorithms based upon the whole task layout, the selected candidate assembly machines and the zoning constraints. A simulation model of a candidate assembly system and the worksheets for simulation data input/output are generated based upon the candidate assembly system layout. Simulation is executed to evaluate cycle times and throughput to achieve the assembled product based upon the simulation model of the candidate assembly system. This is now described in detail.

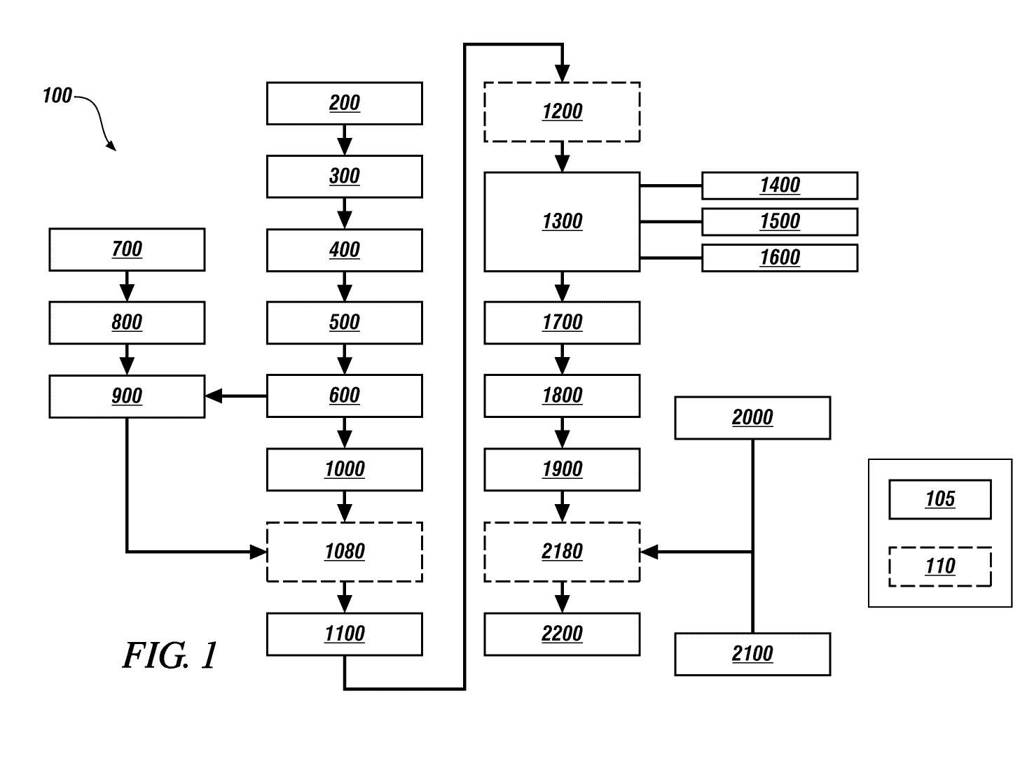

FIG. 1 schematically shows a routine 100 that includes a plurality of discrete, preferably ordered steps for identifying and evaluating candidate assembly systems for producing an assembled product. Each of the steps includes either user input through a graphic user interface or execution of an algorithm. Table 1 is provided as a key wherein the numerically labeled blocks and the corresponding functions are set forth as follows, corresponding to the routine 100.

TABLE 1

| BLOCK | BLOCK CONTENTS |
|---|---|
| 200 | Start |
| 300 | Input bill of materials |
| 400 | Input assembly patterns |
| 500 | Select basic task layouts |
| 600 | Generate whole task layouts |
| 700 | Input standard machine database |
| 800 | Select candidate machines |
| 900 | Evaluate cycle time and cost data |
| 1000 | Input zoning constraints |
| 1080 | Execute optimization algorithm |
| 1100 | Generate optimized system layout |
| 1200 | Generate simulation model and worksheets |
| 1300 | Input basic machine worksheet |
| 1400 | Generate multi-cycle machine information |
| 1500 | Generate multi-task machine information |
| 1600 | Generate multi-task assembly machine information |
| 1700 | Input buffer worksheet |
| 1800 | Input conveyor worksheet |
| 1900 | Input control logic worksheet |
| 2000 | Execute direct replenishment control routine |
| 2100 | Execute tagged replenishment control routine |
| 2180 | Execute simulation software |
| 2200 | Generate simulation output |

Overall, routine 100 may be reduced to practice as a math-based tool for configuring an assembly system for producing an assembled product. By way of example, one embodiment of a lithium battery pack for deployment on a ground vehicle includes several modules. In each module, there is a stack of battery cells and auxiliary components, such as frames, cooling fins and compression foams. The components may be assembled in certain repetitive patterns, such as a frame-cell-foam-cell-fin pattern. Multiple repetitive pattern units may be directly stacked together along with non-repetitive patterns or components on both ends of the stack to form a module or a section. Alternatively, several repetitive pattern units may be encased in a hard metal enclosure or can, which in turn is stacked into a module. In production, there are different ways to configure battery assembly systems. For example, each battery component may be sequentially stacked by an individual machine or station, resulting in a serial transfer line. Alternatively, all the battery components may be assembled in a flexible machine or station, leading to a parallel system with multiple duplicated setups. Alternatively, there may be serial-parallel hybrid system configurations that include some battery components to be pre-assembled into subassemblies, which are next assembled with other components or subassemblies to form the final product.

The routine 100 may be employed to generate candidate assembly system layouts in conjunction with special system requirements or constraints and select an optimal system that satisfies objective functions related to user selected constraints of cost, productivity and quality, all through an analytical or computational system engine. The routine 100 may be implemented as one or a plurality of controller-executed algorithms that employ information that is input by a user through a plurality of graphic user interfaces that are displayed on a computer screen. Certain elements of the routine 100 permit or require user inputs, and are indicated by boxes having solid lines 105. Certain elements of the routine 100 are executable elements or computation engines, and are indicated by boxes having dashed lines 110.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic routines to control operation of actuators. Communications between controllers and between controllers, actuators and/or sensors may be accomplished using a direct wired link, a networked communications bus link, a wireless link or any another suitable communications link. Communications includes exchanging data signals in any suitable form, including, for example, electrical signals via a conductive medium, electromagnetic signals via air, optical signals via optical waveguides, and the like.

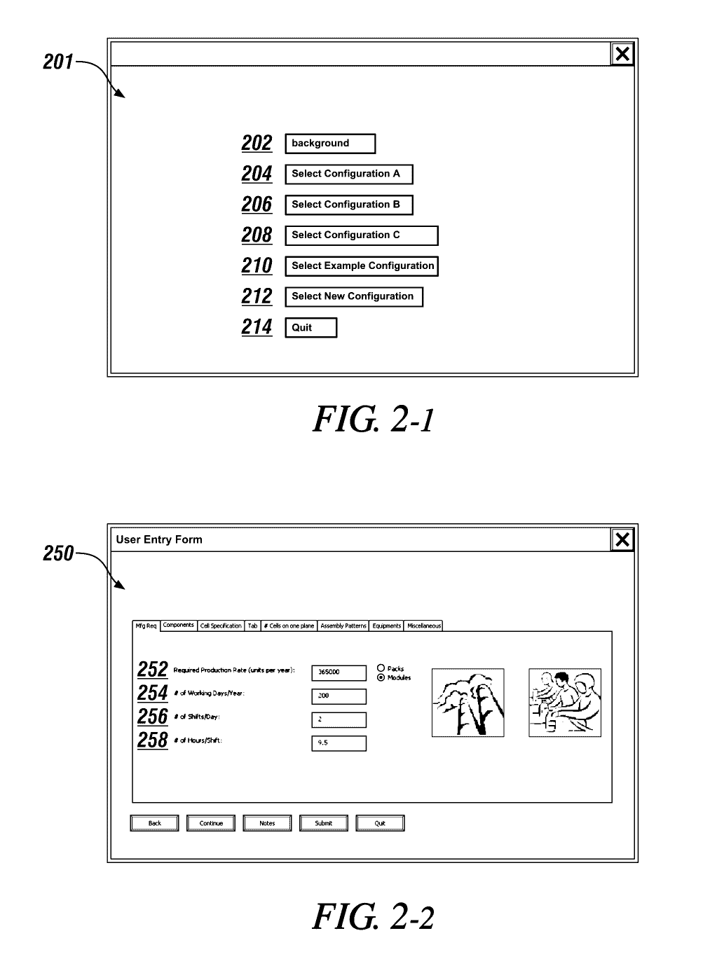

The user may initiate the routine 100 through the start menu 200 that includes a first start menu screen 201, shown with reference to FIG. 2-1, to develop a preferred process for producing an assembled product employing one of an example configuration of an assembly system layout for producing an assembled product, an existing configuration of an assembly system layout for producing an assembled product or a new configuration of an assembly system layout for producing an assembled product. The first start menu screen 201 may include a screen arrangement in the form of user-selectable elements as shown with reference to Table 2, as follows.

TABLE 2

| | |
|---|---|
| 202 | Background |
| 204 | Select Configuration A |
| 206 | Select Configuration B |
| 208 | Select Configuration C |
| 210 | Select Example Configuration |
| 212 | Select New Configuration |
| 214 | Quit |

The user-selectable elements include an example configuration 210, existing configurations A 204, B 206 and C 208, and a new configuration 212 for producing an assembled product. When the user selects one of the configurations for assembly system layouts (204, 206, 208, 210 or 212), the routine 100 seeks input from the user related to production capacity, which is displayed on a production capacity screen 250, shown with reference to FIG. 2-2. The user may enter expected production information in the production capacity screen 250.

The production capacity screen 250 may include a screen arrangement that includes user-selectable contents for basic production operation data, as shown with reference to Table 3, as follows.

TABLE 3

| | | |
|---|---|---|
| 252 | Required Production Rate | #### |
| | (Units per year) | |
| 254 | # of Working Days per year | #### |
| 256 | # of shifts per day | #### |
| 258 | # of hours per shift | #### |

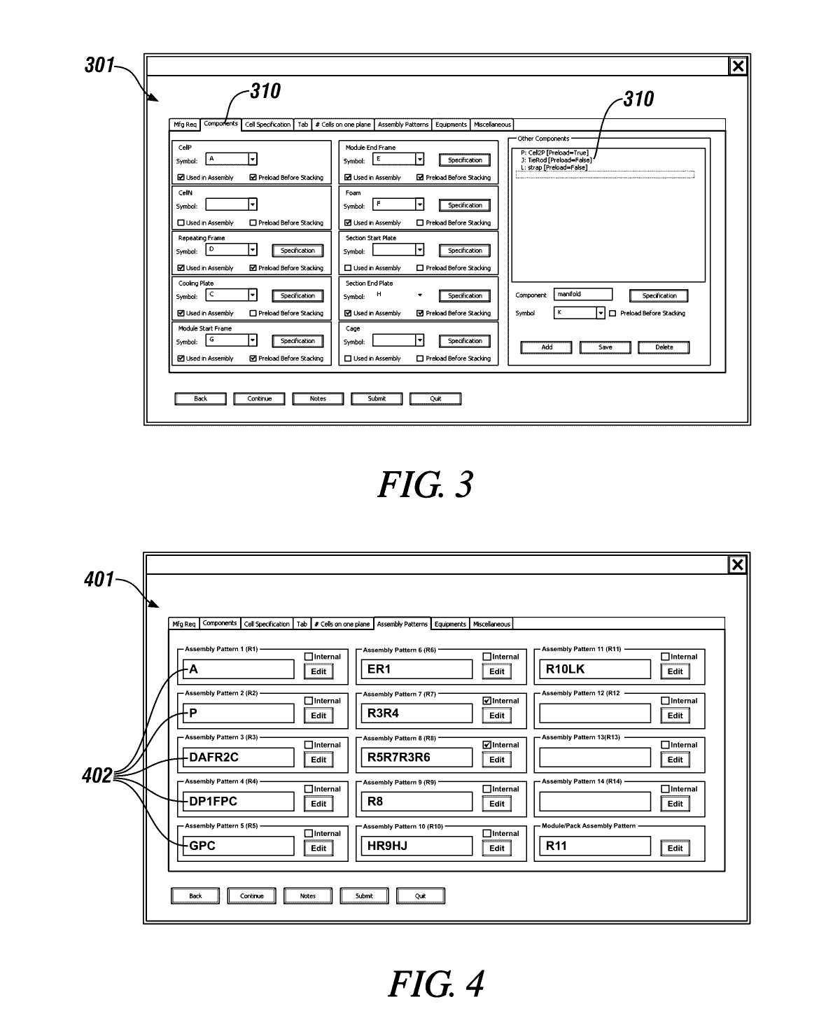

FIG. 3 pictorially shows an embodiment of a bill of materials input screen 301 that enables a user to input a bill of materials including a list of components for an assembled product for use in generating candidate assembly task and system layouts (300). The input screen 301 preferably includes a first section 310 that includes a plurality of known or frequently used components that may be selected for use in an assembled product. The input screen 301 also includes a second section 320 that includes an input screen for adding other components for use in the assembled product. A user may select known components and add other components for the assembled product, including assigning each component with a character symbol, e.g., A-Z. Component specifications, such as dimensions and mass, may be input by the user at that time. Standard or frequently used components may be shown and input on left panes of the menu, special components on the right pane. The user may also indicate whether inputting or loading a component requires a separate assembly machine or operation via a Preload box.

FIG. 4 pictorially shows an embodiment of an assembly pattern input screen 401 that enables a user to input assembly patterns 402 for the assembled product (400). The input assembly patterns 402 may be intermediate assemblies or sub-assemblies of the assembled product. The user preferably breaks down the whole assembly into multiple intermediate or sub-assemblies, called assembly patterns (R1, R2, . . . . ). Each of the assembly patterns 402 may contain a mixture of multiple components or subassemblies, whose symbols are listed in the same order as the actual design of the assembled product.

In each assembly pattern, there may be multiple approaches to assemble the components while maintaining the same order for the assembled product. For example, ABC may be (AB)C, i.e., assembling A and B first into (AB), then assembling (AB) and C; or A(BC), i.e., assembling B and C first into (BC), then assembling A and (BC); or (ABC), i.e., the assembly may be (AB)C this time, A(BC) any other time. An order of (AC)B is not an acceptable approach because it changes the order of assembly requiring B be sandwiched between A and C.

One process for identifying all the combinations of sequencing an assembly pattern may be referred to as enumeration. Enumeration includes identifying all candidate arrangements to assemble components that maintain the same order for the assembled product, including determining an assembly pattern that includes a combination of sequences of components or subassemblies. A control routine may enumerate all candidate assembly tasks or system configurations automatically by converting an assembly layout to a string of characters, such as ((((AB)C)D)E), (ABCDE), ((AB)(CDE)), wherein the characters {A, B, C, D, E} represent the components to be assembled in the listed sequence of ABCDE and each pair of parentheses denotes an assembly operation or task, e.g., stacking The enumeration may be generically stated as a hierarchical grouping problem of P(n) with n elements {a₁, a₂, a₃, . . . aₙ} to be grouped in the listed sequence. The candidate configurations may thus be generated by the following hierarchical and recursive grouping procedures. Overall, this includes step 1, which includes enumerating all the non-repetitive cases for grouping two elements, such as {(a₁a₂)a₃ . . . aₙ}, {a₁a₂(a₃ a₄) . . . aₙ}, . . . {a₁a₂a₃ . . . (an₋₁aₙ)}. Only two elements are merged at a time, and multiple two-element grouping, {(a₁a₂)a₃ . . . (ₐₙ₋₁aₙ)} for example, is not allowed. Under each case, the grouped elements are treated as one integrated element and the enumeration problem degenerates into a P(n-1) problem since there are n-1 elements left. Step 2 follows, wherein all the non-repetitive cases for grouping three elements are enumerated, such as {(a₁a₂a₃) . . . aₙ}, . . . {a₁ . . . aₙ₋₃ (aₙ₋₂aₙ₋₁aₙ)}. Under each case, the grouped elements are treated as one integrated element and the enumeration problem degenerates into a P(n-2) problem since there are n-2 elements. This enumeration operation continues by indexes steps up to step n-1, which includes enumerating the non-repetitive cases for grouping all n elements. Apparently, there is only one set of functional configuration, i.e., (a₁, a₂, a₃, . . . aₙ). At each step of P(n), the i'th step for example, the above procedure is applied to solve the enumeration problem P(n-i). Similarly, at the j'th step of P(n-i), the above procedure is applied again to solve the enumeration problem P(n-i-j). The same recursive enumeration process continues to successive hierarchical levels until there is only one set of candidate system configuration. A filtering function may be embedded in the recursive algorithms to screen out undesirable configurations due to special assembly requirements or constraints.

Table 4 shows one example of enumeration analysis for elements A, B, C, D to determine candidate assembly patterns that include a combination of sequences of components or subassemblies, including a numerical index for identifying a candidate assembly pattern, an enumeration of the multiple approaches to assemble the components while maintaining the same order for the assembled product, and a physical interpretation of the enumeration. Such candidate assembly patterns may be developed for the assembled product.

TABLE 4

| Index | Enumeration | Physical interpretation |
|---|---|---|
| 1 | (1 + 1) + 1 + 1 | ((AB)CD) |
| 2 | ((1 + 1) + 1) + 1 | (((AB)C)D) |
| 3 | (1 + 1) + (1 + 1) | ((AB)(CD)) |
| 4 | 1 + (1 + 1) + 1 | (A(BC)D) |
| 5 | (1 + (1 + 1)) + 1 | ((A(BC))D) |
| 6 | 1 + ((1 + 1) + 1) | (A((BC)D)) |
| 7 | 1 + 1 + (1 + 1) | (AB(CD)) |
| 8 | 1 + (1 + (1 + 1)) | (A(B(CD))) |
| 9 | (1 + 1 + 1) + 1 | ((ABC)D) |
| 10 | 1 + (1 + 1 + 1) | (A(BCD) |
| 11 | (1 + 1 + 1 + 1) | (ABCD) |

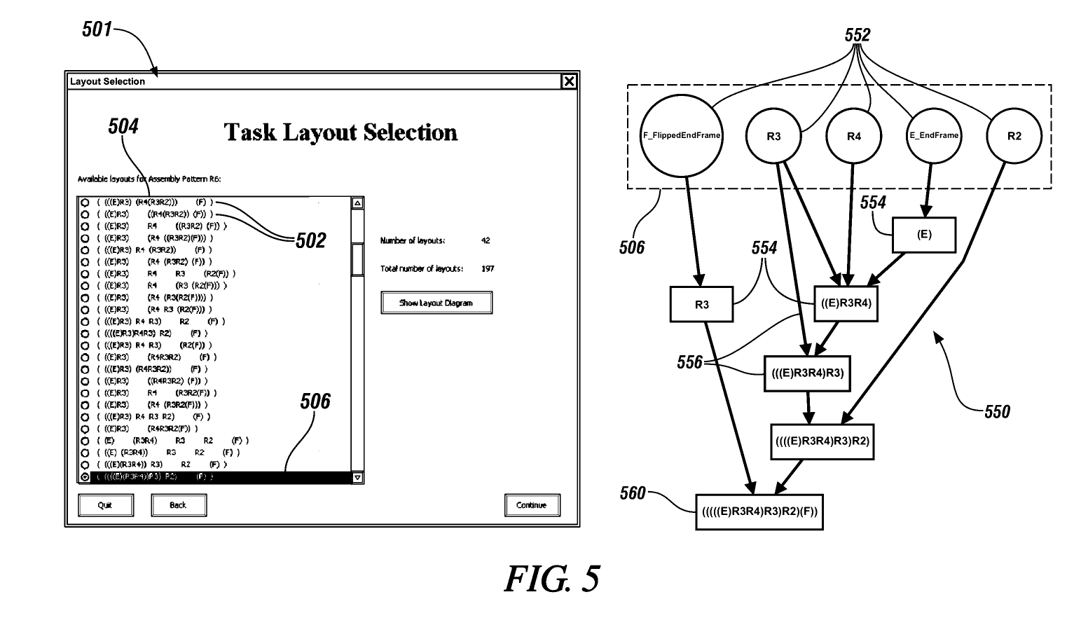

FIG. 5 pictorially shows an embodiment of a basic task layout selection screen 501, including a screen window showing a plurality of candidate basic task layouts 502 for an example assembly pattern 504 arranged in menu form. A basic task layout includes assembly tasks for assembling the assembled product based upon a selected one of the assembly patterns. A basic task layout is accomplished for a single assembly pattern, and there may be multiple assembly patterns arranged serially, in parallel, and/or in cascading order for a whole assembly task. The example assembly pattern 504 includes the following pattern, which is only for purposes of illustration: E-R3-R4-R3-R2-F, wherein each of the elements of the pattern represents a single component or subassembly. As shown, the plurality of candidate assembly layouts 502 is a subset of all possible basic task layouts due to limitations related to screen size, window size, font sizes, and other factors. A specific one of the candidate assembly task layouts 502, i.e., candidate assembly task layout 506 is also indicated. The plurality of candidate assembly task layouts 502 displayed in menu form indicate all candidate ways for making the assembly pattern in combination of sequences of components or subassemblies, and is determined as described with reference to the enumeration algorithm. The user selects one of the basic task layouts (500).

A related assembly layout flowchart 550 may be generated by the controller, and reflects an assembly flowchart for the specific candidate assembly layout 506 that indicates an associated combination sequence for the assembly pattern associated with the candidate assembly task layout 506. As shown, each of the balloons 552 indicates a raw material, and each of the blocks 554 indicates an assembly task, e.g., moving or combining of the raw materials or a subassembly. The blocks 554 indicating assembly tasks are connected by arrows 556, which represent the sequence of actions to achieve an assembled product or subassembly 560. The user selects one to proceed to the combination sequence selection of the next assembly pattern (500).

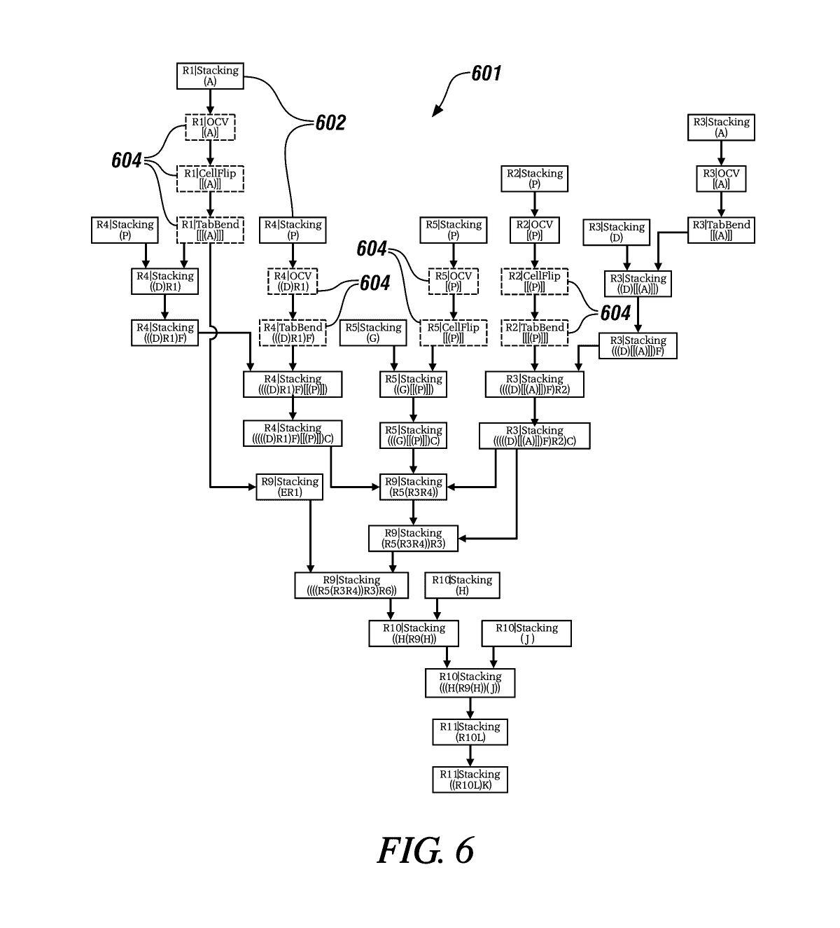

FIG. 6 pictorially shows an embodiment of a single candidate whole task layout screen 601, i.e., a candidate assembly system layout to produce an assembled product, which is generated by the controller based upon previous inputs (600). The candidate whole task layout screen 601 is generated employing results of the basic task layout selection screen 501 and the user selection of combination of sequences for each assembly pattern, one of which is indicated by the candidate assembly task layout 506. Elements of the candidate whole task layout screen 601 include standard assembly tasks that are included in the basic task layout including intermediate assemblies, some of which are indicated by white backgrounds, e.g., element 602. Elements further include non-standard tasks, such as leak testing, visual inspection, electrical testing (OCV, or open-circuit voltage) required to be added in the candidate assembly systems, some of which are indicated by blocks 604 having dashed lines. A user is able to add a non-standard operation before, between or after any of the standard assembly tasks by pointing and clicking on the screen at an appropriate location and entering a non-standard task name. A non-standard task is represented with a pair of square brackets added around the symbol of its preceding task, whether it was standard on non-standard.

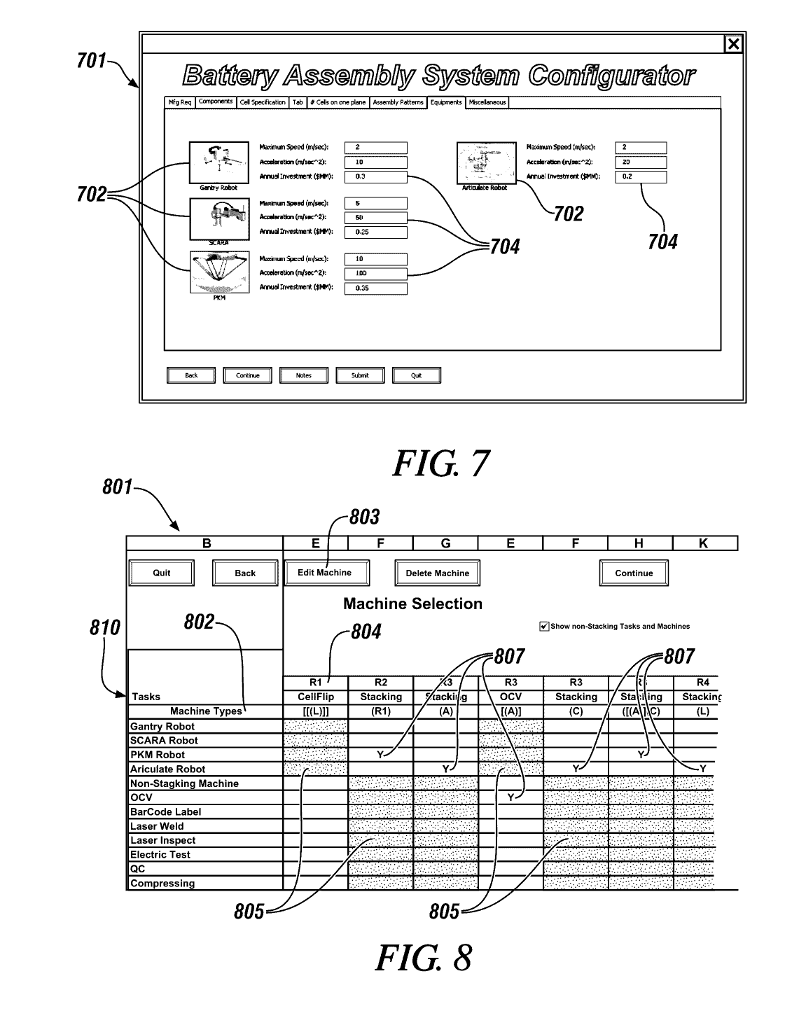

FIG. 7 pictorially shows an embodiment of an assembly machine database screen 701, which enables a user to input and update parameters of various assembly machines (700). The assembly machine database screen 701 identifies and preferably pictorially shows a plurality of assembly machines 702, including, by way of example, a gantry robot, a SCARA (Selective Compliance Articulated Robot Arm) robot, a PKM (Parallel Kinematic Machine) robot and an articulate robot. Each of the assembly machines 702 has corresponding parameters 704 related to performance and cost, including, by way of example, a maximum speed, an acceleration rate and an annual cost investment. The user may change any of the parameters 704 as needed.

FIG. 8 pictorially shows an embodiment of an assembly machine selection screen 801 for selecting candidate assembly machines, and preferably including a menu 810 including a plurality of assembly machine types 802 and tasks 804. This enables a user to select candidate assembly machines (800). The assembly machine types 802 listed are examples for purposes of illustration, and include, by way of example, a gantry robot, a SCARA robot, a PKM robot, an articulate robot and a non-standard assembly machine. The parameter data of the individual machines in the database may be modified by first clicking the screen cursor and thus highlighting on the worksheet cell of an assembly machine in the screen 801 and then clicking the edit machine button 803. A sub-menu (not shown) will pop-up for the user to change the parameter data. The edit machine button 803 can also be used to add a new assembly machine by clicking and highlighting a blank cell in the column of assembly machine type 802.

A gantry robot is configured to move along three linear axes (X,Y,Z), thus having a work envelope that is in rectangular block shape. The Cartesian (X,Y,Z) configuration allows the gantry robot to be highly customizable within its work envelope. Payload and speed may vary with selection or design of actuators, axis lengths and support structure. The advantages of gantry robots include easy workspace planning, ease of configuration by stacking up linear actuators, and best accuracy and repeatability due to higher structural rigidity. Some gantry robots are inefficient in spatial utilization due to fixed length of the moving axes.

A SCARA robot may have four axes of motion with three operating in a cylindrical work envelope and the remaining one for rotating part orientation. The robot arm may be slightly compliant horizontally, in X-Y plane, but rigid in the vertical Z direction. SCARA robots are fast with repeatable movement, and are low cost with a small footprint. SCARA robots are known to be small in size and with relatively low payload capacity.

An articulated robot has high level of flexibility as a result of six rotational axes or joints, closely resembling a human arm and wrist combined. The six rotational joints allow an articulated robot to reach a spherical workspace which is much larger than the length of individual mechanical links and, at the same time, lets the articulated robot grasp or move parts flexibly in all orientations or paths. The articulated robots are hence the most compact material handling equipment. However, the serially connected link arms and joints with servo motors and attached cabling form a relatively heavy, long-stretched mass or inertia that may hamper their speed, response time and structural rigidity. Furthermore, articulated robots may be less accurate due to the serially connected rotary joints with the nature of amplifying motion errors through the linkage as compared to the fixed, independent inaccuracies of gantry robot axes.

A PKM robot has a configuration with multiple sets of serial linkages that are connected together at both a fixed base and a moving platform. Each serial linkage has an independently controllable linear or rotary actuator. By coordinating the motion of the actuators, the PKM robot may function as a three-axis robot for moving parts in a conical-like workspace. Similarly, by adding a wrist with extra axes, the PKM robot may change part orientations on the moving platform. There are various PKM concepts.

Non-direct assembly tasks may include an open-circuit voltage tester (OCV), a bar code label reader (BarCode Label), a welder (Laser Weld), a weld inspector (Laser Inspect), an electrical continuity tester (Electric Test), quality control monitor (QC), and a compressing device. Other machine types may be employed in place of or along with the example machine types 802 that are listed. Tasks 804 are associated with each of the machine types 802 and include standard or non-standard tasks, e.g., R1, R2, R3 and R4, which are shown in a first line. Task names include, by way of example, a Cell Flip, Stacking, and OVC. Shaded portions 805 on the menu 801 indicate tasks that the associated assembly machine type may not be able to accomplish. The shaded portions 805 indicate that the assembly machines for non-standard assembly tasks cannot be picked for standard tasks and vice versa. For nonstandard tasks, normally only one specific machine type may be selected for an assembly process. Selected elements 807 (Y) indicate a selected or preferred machine type for the associated task. The menu 801 displays all available assembly machines for performing standard or non-standard assembly tasks. For standard tasks, the user may pick multiple types of assembly machines. Optimization algorithms will assist in selecting a preferred one of the type of assembly machines. Machine parameters such as cycle time and cost of each type of the assembly machines may be modified by the user as needed.

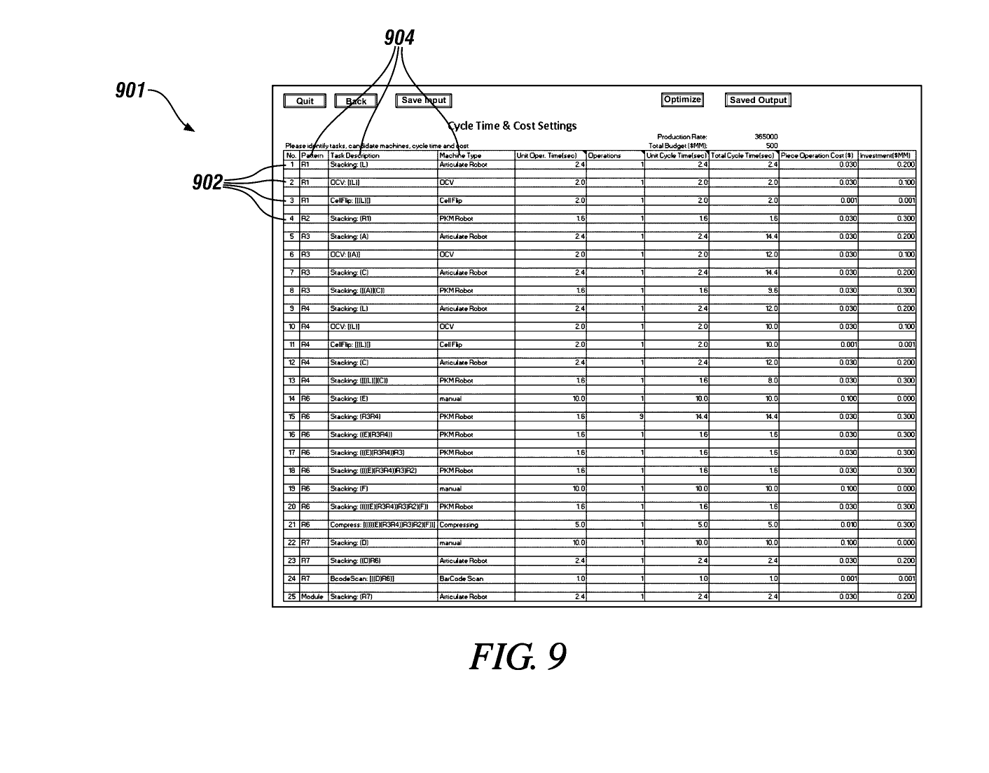

FIG. 9 pictorially shows an embodiment of a spreadsheet screen 901 that indicates tasks, candidate machines, cycle times and costs for a plurality of identified tasks, e.g., those associated with the candidate whole task layout 601 described herein and shown with reference to FIG. 6. The individual lines 902 of the spreadsheet 901 (No. 1-25) indicate the identified tasks. The individual columns 904 include task number (No.), assembly pattern (Pattern), description of the assembly task (Task Description), selected assembly machine type (Machine Type), operating time to accomplish an individual task (Unit Oper. Time(sec)), quantity of operations (Operations), operating time to accomplish the assembly task (Unit Cycle Time(sec)), a total cycle time (Total Cycle Time(sec)), piece cost (Piece Operation Cost($)), and total monetary investment ($MM) for the assembly machine. The data are generated automatically by the control routine based on prior user input as well as embedded database and calculation formulae (900). The data in the spreadsheet will be the input to the system optimization computations for determining an optimized system layout. The user may still fine tune the unit cycle time and cost data in the spreadsheet screen 901 for improved accuracy.

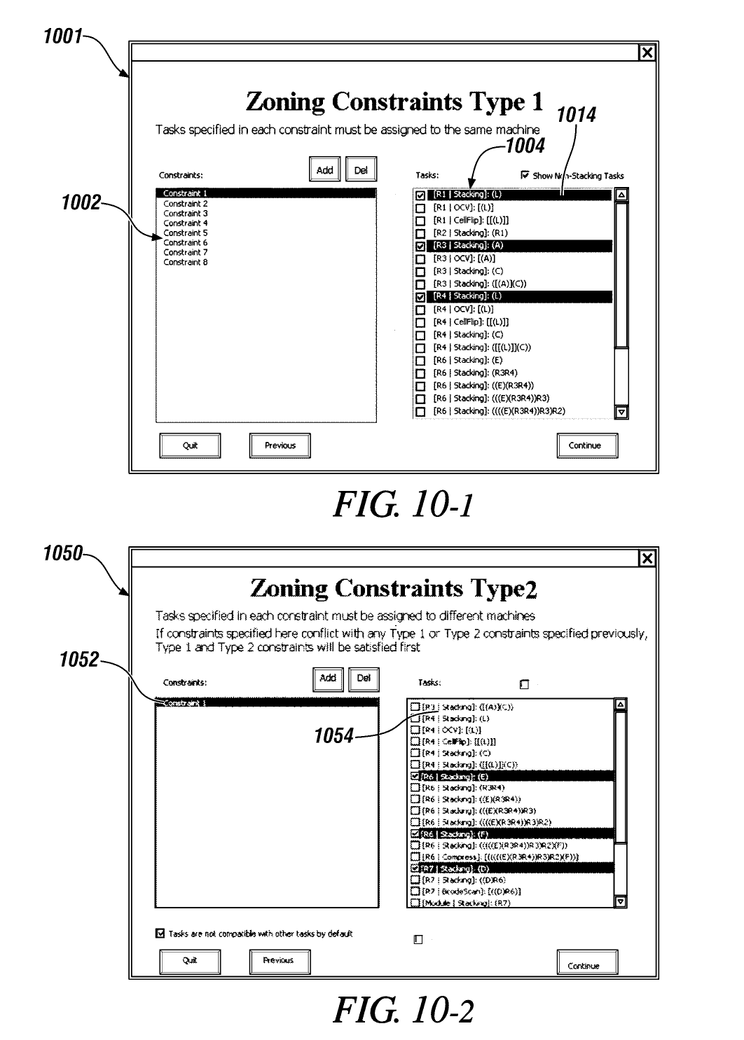

FIGS. 10-1 and 10-2 pictorially show embodiments of zoning constraints screens that provide inputs to the control routine. The user is able to input the zoning constraints to the control routine via the zoning constraints screen (1000). Zoning constraints include constraints that restrict assembly tasks to a single assembly machine and constraints that separate assembly tasks to separate assembly machines. FIG. 10-1 graphically shows a first screen 1001 showing the constraints that restrict assembly tasks to a single assembly machine, referred to herein as Type 1 zoning constraints (Zoning Constraints Type 1). These may be user-selectable constraints that indicate tasks that must be or should be assigned to the same assembly machine. The first screen 1001 includes a first menu 1002 including a plurality of selectable constraints (Constraint 1, . . . Constraint 8) that may be added or deleted. Each of the selectable constraints is definable. The user may define or add constraints to assembly tasks for better efficiency or nature of assembly. The first screen 1001 includes a second menu 1004 including a plurality of selectable tasks 1014, e.g., R1, R2, R3, R4 and R6, that may have one of the selectable constraints assigned as part of a Type 1 zoning constraint indicating the tasks that must be or should be assigned to the same assembly machine. By way of example, a multi-function office machine that can scan, print and fax is more space-efficient than three separate machines performing each task individually, and thus indicates one form of a Type 1 zoning constraint.

FIG. 10-2 pictorially shows a second screen 1050 showing one or a plurality of the constraints that forcibly separate assembly tasks to different assembly machines, referred to herein as Type 2 zoning constraints (Zoning Constraints Type 2). These may be user-selectable constraints that indicate assembly tasks are incompatible and must be assigned to different assembly machines. Examples of incompatible assembly tasks include painting and welding. The second screen 1050 includes a first menu 1052 including a selectable constraint (Constraint 1) that may be added or deleted. Each of the selectable constraints is definable. The user may define or add incompatible constraints. The second screen 1050 includes a second menu 1054 including a plurality of selectable tasks, e.g., R3, R4 and R7, that may have one of the selectable constraints assigned as part of a Type 2 zoning constraint indicating the tasks are incompatible and must be assigned to different assembly machines.

An optimization algorithm is executed (1080) to generate an optimized system layout in the form of a candidate assembly system layout (1100).

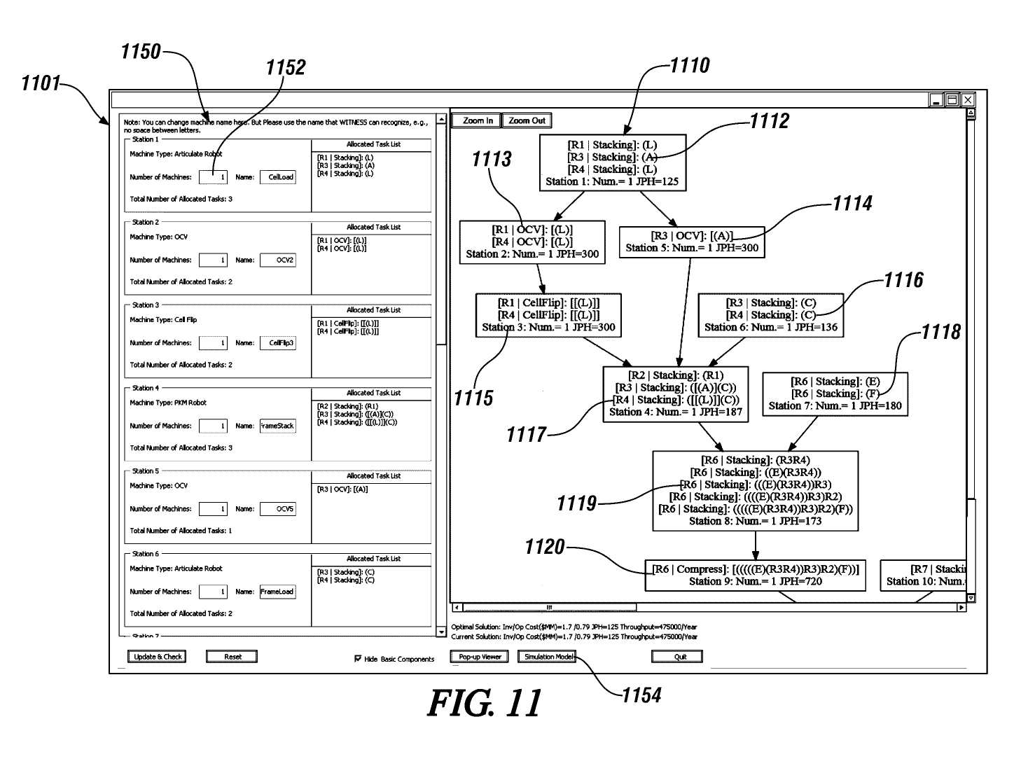

FIG. 11 pictorially shows a screen 1101 associated with results of generating the candidate assembly system layout, e.g., as described with reference to FIG. 6 and taking into account the Type 1 and Type 2 zoning constraints described with reference to FIGS. 10-1 and 10-2. The screen 1101 shows in block diagram form a portion of candidate assembly system layout 1110 and associated user input menu 1150. The assembly system layout 1110 is shown in a flow chart including a plurality of block diagram elements 1112 through 1120. The example assembly system layout 1110 corresponds to one of the candidate whole task layouts 601 described with reference to FIG. 6. Each of the block diagram elements 1112 through 1120 represents an assembly station, e.g., Station 1, Station 2, etc., and shows example components, subassemblies and processes involved in the associated assembly station. Related information may include a quantity of assembly machines at the station (e.g., Num.=1) and jobs per hour (JPH) from the associated assembly station. Results may further include information related to a yearly throughput, investment and operating cost.

The user input menu 1150 includes a plurality of station descriptors that correspond to the assembly stations, e.g., Station 1, Station 2, etc. The station descriptors each include a station name, e.g., Station 1, a machine type, a quantity of the machines at the station (Number of Machines) and an associated name (Name), a quantity of tasks allocated to the station (Total Number of Allocated Tasks:), and a list of the allocated tasks (Allocated Task List) wherein the allocated tasks are derived from the candidate whole task layout 601 described with reference to FIG. 6. The user input menu 1150 permits a user to manually select and input a quantity of the machines at the station (Number of Machines) 1152, thus permitting the user to execute what-if scenarios by changing the number of machines in a station and generating a related candidate assembly system layout based upon the updated values. The user is thus able to generate a simulation model of a candidate assembly system associated with the candidate assembly system layout 1110. The candidate assembly system may be employed in a simulator for evaluating throughput.

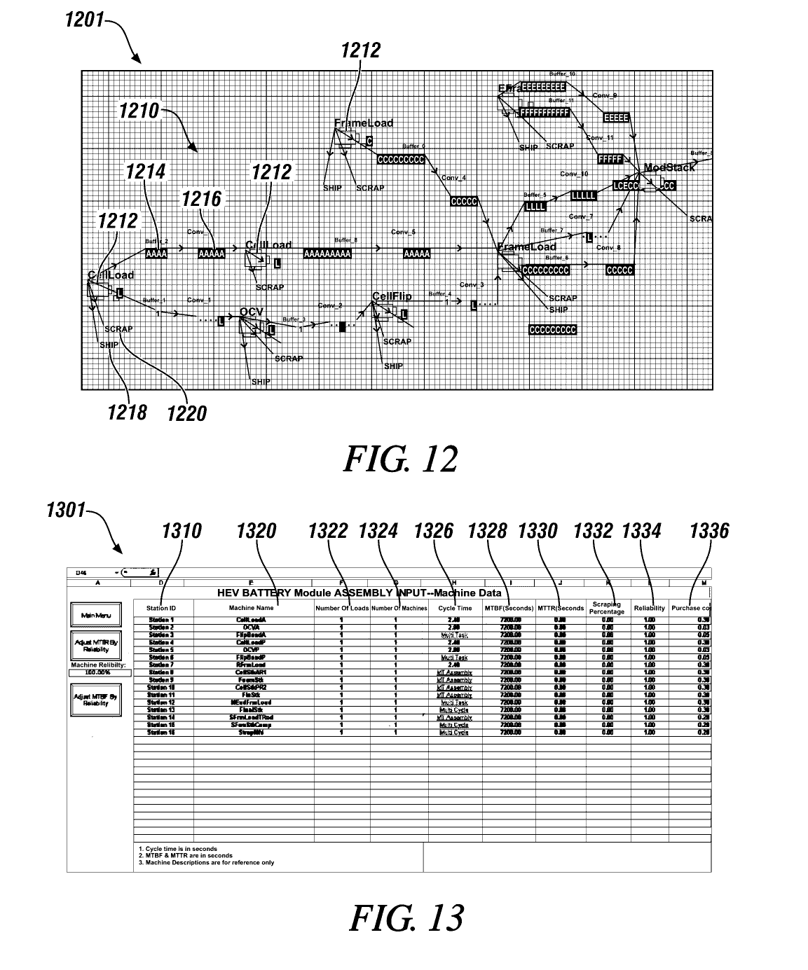

FIG. 12 pictorially shows a screen 1201 including a portion of a simulation model of a candidate assembly system 1210 associated with the candidate assembly system layout 1110 that is generated by the control routine (1200). The simulation model of the candidate assembly system 1210 for the candidate assembly system layout 1100 may be provided as input to a commercially available simulation software package to evaluate cycle times and throughput to achieve the assembled product. Known simulation software packages employ mathematical formulae to represent and model a process including a plurality of discrete events related to behaviors of elements in a manner that facilitates predictive experimentation, taking into account factors related to device performance, constraints, resources, and others. Elements of the candidate assembly system 1210 include a plurality of stations (CellLoad, OCV, etc.) 1212, a plurality of buffers (Buffer_1, etc.) 1214, a plurality of conveyors (Cony_1, etc.) 1216, and related inputs, outputs (SHIP) 1218 and scrap actions (SCRAP) 1220.

FIG. 13 schematically shows a basic machine worksheet 1301 that is generated for input to the simulator that is associated with the simulation model 1201 of the candidate assembly system 1210 with reference to FIG. 12 (1300). The basic machine worksheet 1301 identifies a plurality of identified stations (Station ID) 1310, and associated names (Machine Name) 1320, with example associated factors including Number of Loads 1322, Number of Machines 1324, Cycle Time 1326, MTBF (seconds) 1328, MTTR (seconds) 1330, Scrapping Percentage 1332, Reliability 1334, and Purchase Cost 1336 for each of the stations.

The basic machine worksheet 1301 is automatically generated for the candidate assembly system 1210, with the input values, e.g., cycle times derived from inputs. Values for MTBF (“Mean Time Between Failure”) 1328, MTTR (“Mean Time To Repair”) 1330 and Scrap Rate 1332 are populated with default values, and may be set by the user. Furthermore, details of multi-cycle machines (“Multi-Cycle”), multi-task machines (“Multi-Task”) and multi-task assembly machines (“MT Assembly”) may be input via worksheets. By way of definition, a simple machine has a single input and a single output, an assembly machine has multiple inputs and a single output, a multi-task machine has a single input and multiple outputs and a multi-task assembly machine has multiple inputs and multiple outputs. Production scrapping, if not properly managed in either parts replenishment or assembly tasks allocation, may result in system stoppage due to empty input (starving) or over-filled output (blocking).

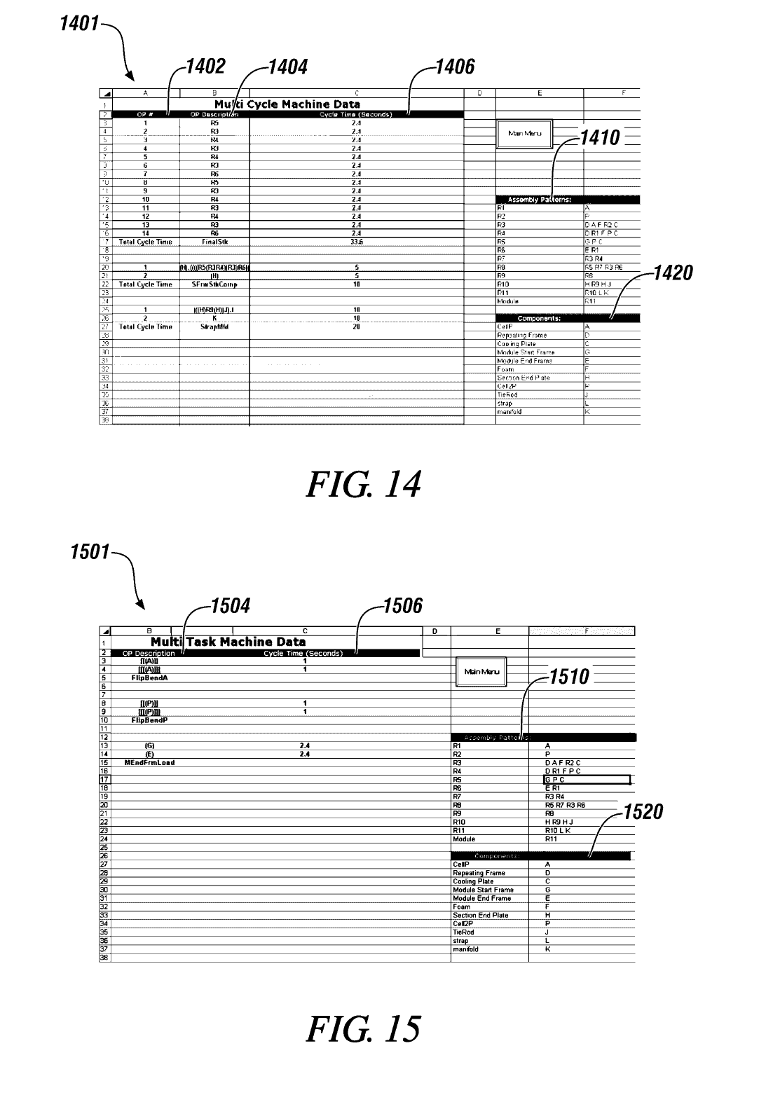

FIG. 14 schematically shows an example of a multi-cycle machine input worksheet 1401 that is generated for simulation of one of the multi-cycle machines engaged in repetitive assembly of parts (1400). Worksheet 1401 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include operation number (OP #) 1402, operation description (OP Description) 1404 and cycle time (Cycle Time (Seconds)) 1406, shown in contiguous columns, with a plurality of assembly patterns (R1, etc.) 1410 and components (CellP, etc.) 1420 included. The assembly patterns (R1, etc.) 1410 and components (CellP, etc.) 1420 are derived from the task layout inputs described with reference to FIGS. 4 through 6. The user is able change any of the data in the worksheet 1400 to execute what-if simulation and analysis.

FIG. 15 schematically shows an example of a multi-task machine input worksheet 1501 for simulation of one of the multi-task machines engaged in repetitive assembly of parts (1500). Worksheet 1501 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include operation description (OP Description) 1504 and cycle time (Cycle Time (Seconds)) 1506, shown in contiguous columns, with a plurality of assembly patterns (R1, etc.) 1510 and components (CellP, etc.) 1520 included. The assembly patterns (R1, etc.) 1510 and components (CellP, etc.) 1520 are derived from the task layout inputs described with reference to FIGS. 4 through 6. The user is able change any of the data in the worksheet 1500 to execute what-if simulation and analysis.

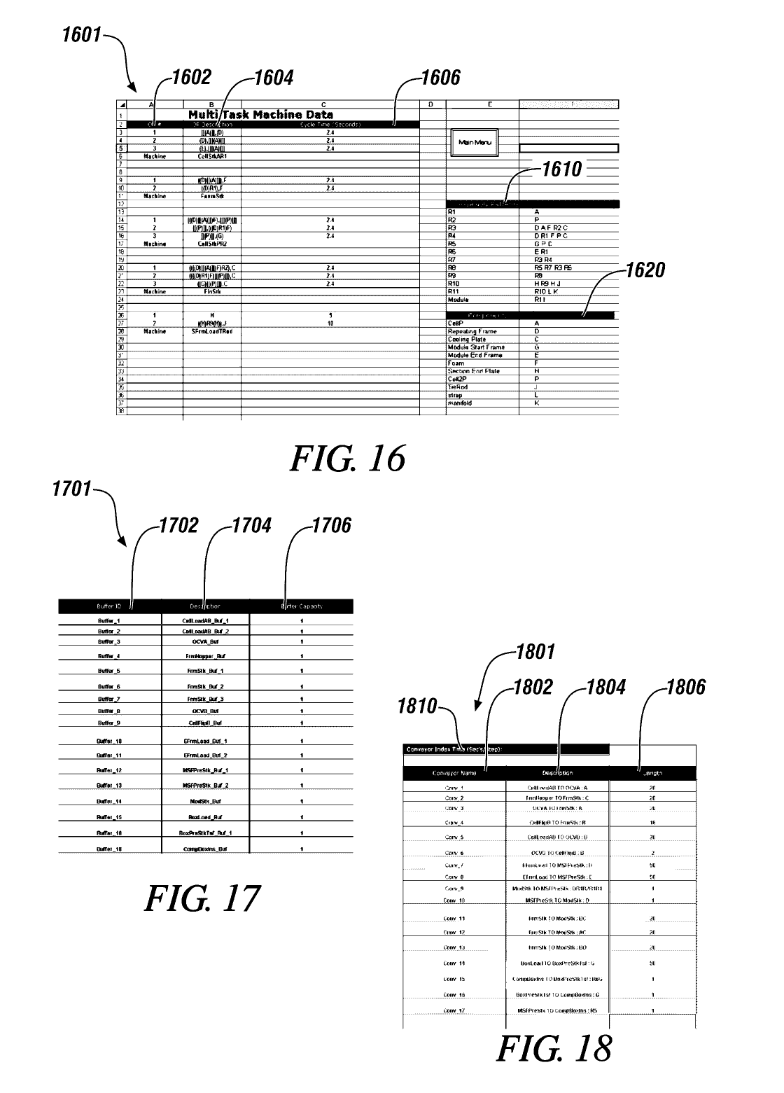

FIG. 16 schematically shows an example of a multi-task assembly machine input worksheet 1601 for simulation of one of the multi-task assembly machines engaged in repetitive assembly of parts (1600). Worksheet 1601 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include operation number (OP #) 1602, operation description (OP Description) 1604 and cycle time (Cycle Time (Seconds)) 1606, shown in contiguous columns, with a plurality of assembly patterns (R1, etc.) 1610 and components (CellP, etc.) 1620 included. The assembly patterns (R1, etc.) 1610 and components (CellP, etc.) 1620 are derived from the task layout inputs described with reference to FIGS. 4 through 6. The user is able change any of the data in the worksheet 1600 to execute what-if simulation and analysis.

FIG. 17 schematically shows an example of a buffer worksheet 1701 for simulation of one of the buffers engaged in the assembly system (1700). Worksheet 1701 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include Buffer identification (Buffer ID) 1702, location description (Description) 1704 and capacity (Capacity) 1706, shown in contiguous columns. The capacity of each of the buffers has a default value of 1. The user is able change any of the data in the worksheet 1701 to execute what-if simulations and analyses.

FIG. 18 schematically shows an example of a conveyor worksheet 1801 for simulation of one of the conveyors engaged in the assembly system (1800). The conveyor worksheet 1801 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include the conveyor index time (Conveyor Index Time (Sec's/Step) 1810, conveyor name (Conveyor Name) 1802, location description (Description) 1804 and linear length (Length) 1806, shown in contiguous columns. The length of each of the conveyors has a default value of 1. The conveyor index time 1810 has a default value of 1 second. The user is able change any of the data in the worksheet 1801 to execute what-if simulation and analysis.

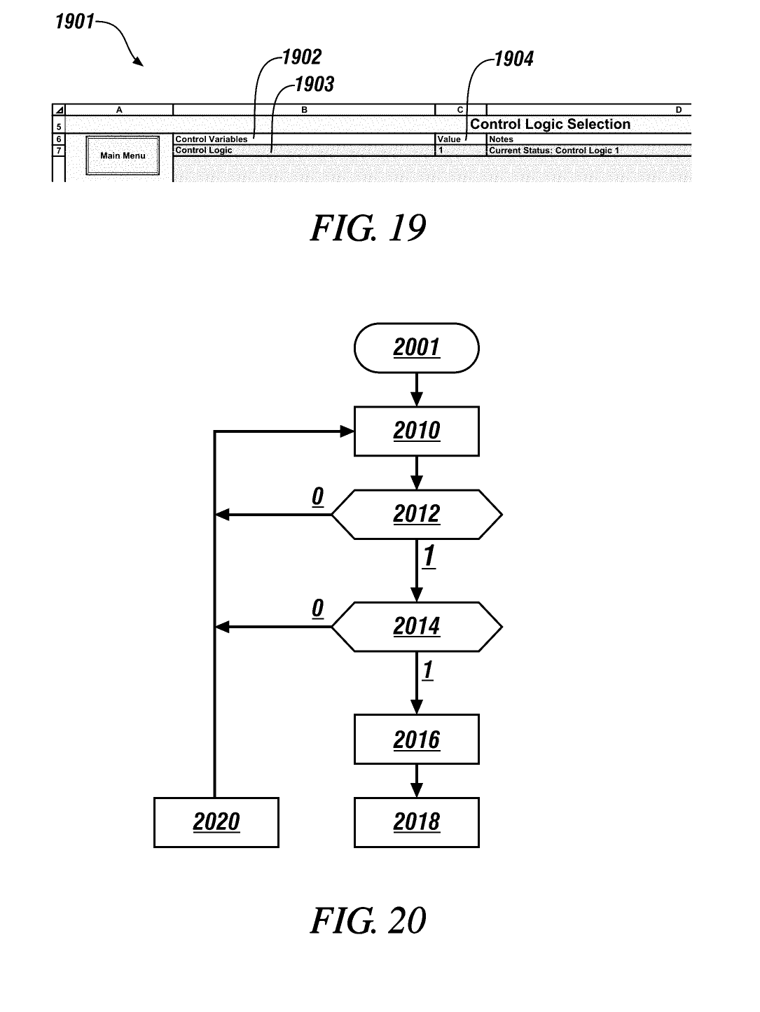

FIG. 19 schematically shows an example of a control logic selection worksheet 1901 for selecting one of an input or output control logic, e.g., for selecting a mechanism for handling part scrapping and machine replenishment for simulation of the assembly system (1900). The control logic selection worksheet 1901 may be automatically generated and supplied as input to the basic machine worksheet 1301 shown with reference to FIG. 13 for input to the simulator that is associated with the simulation model 1201 of the candidate assembly system 1210 with reference to FIG. 12. Inputs include one or a plurality of control variables 1902 and associated value 1904. A single control variable is shown, indicated as Control Logic 1903 with a user-selectable value of 1 as shown. The user is able change any of the data in the control logic selection worksheet 1901 to execute what-if simulations and analyses. Production scrapping, if not properly managed in either parts replenishment or assembly tasks allocation, may result in system stoppage due to empty input (starving) or over-filled output (blocking) There may be two control logic algorithms for managing part scrapping at multi-task assembly machines, referred to as direct replenishment and tagged replenishment.

FIG. 20 schematically shows a direct replenishment control routine 2001 for controlling a multi-task assembly machine. In normal production, each multi-task assembly machine processes parts based on a prescribed task sequence and quantity. The multi-task assembly machine constantly checks for the parts inventory of its input lines and output lines. If an input line is empty or an output line is full for the present task, the machine skips the task to the next one immediately until a task that has both the input parts and output space available (2000). This operation is executed in an embodiment of the direct replenishment control routine 2001. Table 5 is provided as a key wherein the numerically labeled blocks and the corresponding functions are set forth as follows, corresponding to the direct replenishment control routine 2001.

TABLE 5

| BLOCK | BLOCK CONTENTS |
|---|---|
| 2001 | Direct replenishment control routine |
| 2010 | Next task |
| 2012 | Input parts available? |
| 2014 | Output space available? |
| 2016 | Input parts per task |
| 2018 | Process assembly per task |
| 2020 | Push assembly output per task |

The direct replenishment control routine 2001 preferably executes after the completion of each of its assigned tasks, which are preferably sequentially executed. Upon initiating a new task (2010), the multi-task assembly machine determines whether input parts have been supplied to its input lines, i.e., whether input parts are available (2012), and if so (2012)(1), determines whether there is output space (2014). If so (2014)(1), parts are input to the multi-task assembly machine according to its assigned task (2016) and the task assembly process is executed per the assigned task (2018), and the assembled part is pushed to the output of the multi-task assembly machine (2020). If there are no input parts available (2012)(0), or if there is no available output space (2014)(0), the multi-task assembly machine skips the task to execute the next task and the assembled part is pushed to the output of the multi-task assembly machine (2020). This direct replenishment control routine 2000 may be employed and simulated in the simulator as part of its analysis.

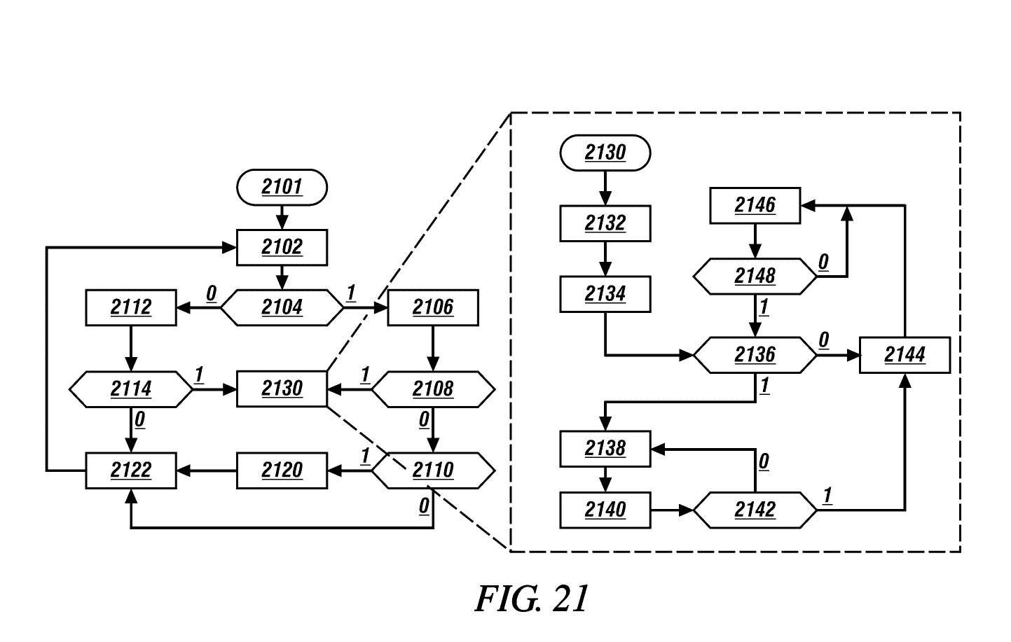

FIG. 21 schematically shows a tagged replenishment control routine 2101 for controlling a multi-task assembly machine. In normal production, each multi-task assembly machine processes parts based on a prescribed task sequence and quantity. Any scrapping occurrence in the system will notify the front loading machines to replenish the raw materials that constitute the scrapped assembly right after the present regular release cycle of raw materials is completed. The replenished materials or parts are tagged to identify the task, in particular, where the multi-task assembly machine scraps. The replenishments will be processed per the tagged task, then the machine resumes its regular task sequence of assembly. If the replenishments happen to be processed by the machine relating to the tags, the tags are removed from the assembly; otherwise, the tags remain with the replenished parts (2100). This operation is executed in an embodiment of the tagged replenishment control routine 2101. Table 6 is provided as a key wherein the numerically labeled blocks and the corresponding functions are set forth as follows, corresponding to the tagged replenishment control routine 2101.

TABLE 6

| BLOCK | BLOCK CONTENTS |
|---|---|
| 2101 | Tagged replenishment control routine |
| 2102 | Input new parts |
| 2104 | Are parts tagged? |
| 2106 | Process task per tag |
| 2108 | Is it a scrap? |
| 2110 | Is it a tag-to task? |
| 2112 | Process task per sequence |
| 2114 | It is a scrap? |
| 2120 | Remove tags |
| 2122 | Push assembly to output per task |
| 2130 | Push to scrapping process |
| 2132 | Replenish request to ON |
| 2134 | Identify replenish materials, scrap task machine |
| 2136 | Is there a replenish request? |
| 2138 | Replenish material release cycle |
| 2140 | Tag replenish parts |
| 2142 | Is cycle done? |
| 2144 | Execute next release cycle |
| 2146 | Regular raw material release cycle |
| 2148 | Is cycle done? |

Operation of one embodiment of the tagged replenishment control routine 2101 for controlling a multi-task assembly machine includes inputting new parts to the multi-task assembly machine (2102) and determining if the parts are tagged (2104). If not tagged (2104)(0), the task is processed per the planned sequence (2112), and the part is evaluated to determine if it is a scrap part (2114). If not a scrap part (2114)(0), the assembly is pushed to the output per the task (2122). If tagged (2104)(1), the task is processed per the tag (2106), and the part is evaluated to determine if it is a scrap part (2108). If not a scrap part (2108)(0), the tag is evaluated to determine if it is tagged to the task (2110). If tagged to the task (2110)(1) the tags are removed (2120) and the assembly is pushed to the output per the task (2122). If not tagged to the task (2110)(0) the assembly is pushed to the output per the task (2122). If the part is a scrap part (2114)(1) or (2108)(1), the part is pushed to a scrapping process (2130). The scrapping process (2130) including executing a replenish request is activated (2132), and the replenishment materials and scrap task machine are identified (2134). The routine verifies the replenishment (2136), and if active (2136)(1), executes a replenish material release cycle (2138) and tags the replenishment part or parts (2140) and evaluates whether the replenishment material release cycle is complete (2142). This operation continues to execute the replenish material release cycle (2138) and tag the replenishment part or parts (2140) until the replenishment material release cycle is complete (2142)(1). When the replenishment material release cycle is complete (2142)(1) or the replenishment request is inactive (2136)(0), the next release cycle is executed (2144), which includes executing a regular raw material release cycle until complete (2146), (2148)(0) and (2148)(1). This tagged replenishment control routine 2100 may be employed and simulated in the simulator as part of its analysis.

The aforementioned information is input to a simulation tool, i.e., a simulator, which evaluates the candidate assembly system and provides results. Simulation tools in the form of controller-executable software are commercially available, and thus not discussed in detail herein. Such simulation tools include generating statistically accurate models, e.g., one of the candidate whole task layouts 600 that represent behaviors of the system for predictive experimentation.

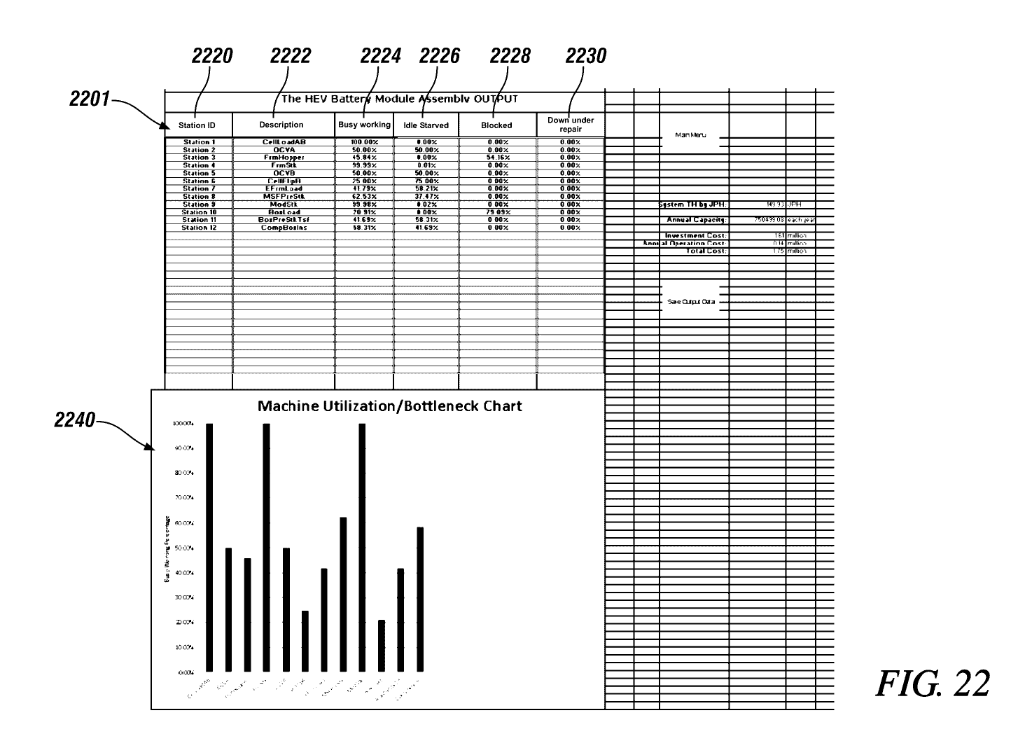

FIG. 22 pictorially shows an example of an output worksheet screen 2201 that is output from the simulator that is associated with the simulation model 1201 of the candidate assembly system 1210 with reference to FIG. 12 to generate simulation output (2200). The output worksheet 2201 identifies a plurality of identified stations (Station ID) 2220, and associated names (Description) 2222, and resulting evaluations in the form of % time working (Working) 2224, % of time idle or starved (Idle Starved) 2226, % of time blocked (Blocked) 2228 and % of time under repair (Down under repair) 2230, with an associated graphical depiction of the aforementioned evaluations 2240.

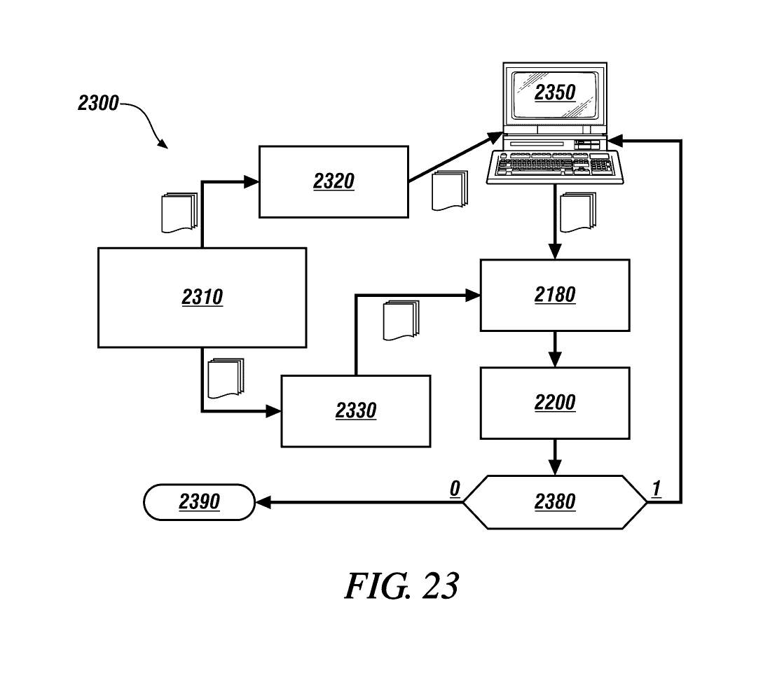

FIG. 23 schematically shows a simulation process overview 2300 for gathering information to generate candidate assembly system configurations that may be subjected to process simulation for evaluation in conjunction with system requirements and constraints. The simulation process overview 2300 includes control routines in the form of algorithms and related control routines that reside in memory devices accessible by a controller 2350 that includes a graphic user interface in the form of a touchscreen, keyboard or another suitable mechanism. The control routines preferably include algorithms related to the elements of routine 100 described with reference to FIG. 1 and related FIGS. 2-22 in the form of discrete, ordered steps for identifying and evaluating candidate assembly systems for producing an assembled product. This preferably includes product and process input menus, task layout generation and selection, system constraint selection menus, basic machine data generation to optimize system layouts and machine data (2310).

A first application program interface (API) 2320 translates user inputs related to machines, buffers, conveyors, control logic to information usable in simulation software, and a second API 2330 generates simulation models of candidate assembly system configurations and scrap control logic to information usable in simulation software, e.g., as described with reference to FIGS. 1-21. All the aforementioned information is communicated to process simulator 2180, which simulates operations and generates evaluations, e.g., shown as the output worksheet 2200 with reference to FIG. 22. A user is able to review the information and decide to execute additional simulations (2380)(1) or end execution (2380)(0), 2390. One of the candidate system layouts that satisfies an objective function in terms of cost, productivity and/or quality may be selected as a preferred system layout for implementation. The method is reduced to practice as a flexible, fast processing and easy-to-use math-based tool for high level planning and configuration of assembly systems.

The results for a plurality of candidate systems may be combined with any constraints, such as a simplified system policy that requires each task to be assigned to only one type of assembly machine, a balanced material flow policy requiring an upstream assembly or subassemblies to be finished before the downstream tasks can be processed, a system cost restraint that requires the total investment and operating cost to not exceed the budget limit, and a requirement that the system throughput has to meet or exceed the required production volume. The results for the candidate systems may be subjected to linear programming to identify a preferred assembly system layout that minimizes the objective function, e.g., minimizes costs. The concepts described herein provide user-friendly simulation without the complexity of manual modeling, including an ability to rapidly model and simulate candidate assembly systems for system optimization and decision making This facilitates assembly system planning and decision making and reduced time and cost for production system simulation.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for generating a candidate assembly system layout for an assembled product, the method comprising:
inputting a bill of materials to a controller including a list of components for the assembled product;
determining, by the controller, a plurality of assembly patterns for the assembled product including a plurality of intermediate assemblies and sub-assemblies;
determining a basic task layout including assembly tasks for assembling the assembled product based upon a selected one of the assembly patterns;
generating, by the controller, a whole task layout based upon the basic task layout for the selected assembly pattern;
selecting candidate assembly machines for the whole task layout;
identifying zoning constraints for the candidate assembly machines related to assembly tasks;
generating, by the controller, a candidate assembly system layout based upon the whole task layout, the selected candidate assembly machines and the zoning constraints;
generating a simulation model of a candidate assembly system based upon the candidate assembly system layout; and
executing a simulation of the candidate assembly system to evaluate cycle times and throughput to achieve the assembled product based upon the simulation model.

2. The method of claim 1, wherein determining the plurality of assembly patterns for the assembled product including a plurality of intermediate assemblies and sub-assemblies further comprises executing enumeration to identify candidate combinations of sequences of components and subassemblies to assemble the components that maintain the same order for the assembled product.

3. The method of claim 1, wherein generating a whole task layout based upon the basic task layout for the selected assembly pattern comprises incorporating non-standard tasks into the basic task layout.

4. The method of claim 3, wherein incorporating non-standard tasks includes incorporating tasks related to leak testing and electrical testing into the basic task layout.

5. The method of claim 1, wherein identifying zoning constraints for the candidate assembly machines comprises identifying constraints that restrict assembly tasks to a single assembly machine and identifying constraints that separate assembly tasks to separate assembly machines.

6. The method of claim 1, wherein generating a simulation model of a candidate assembly system based upon the candidate assembly system layout further comprises generating a basic machine worksheet identifying workstations and associated factors related to quantity of assembly machines, cycle times, reliability and cost.

7. The method of claim 1, wherein generating a simulation model of a candidate assembly system based upon the candidate assembly system layout further comprises generating a multi-cycle machine input worksheet for simulating a multi-cycle machine as an element of the candidate assembly system layout related to one of the assembly patterns.

8. The method of claim 1, wherein generating a simulation model of a candidate assembly system based upon the candidate assembly system layout further comprises generating a multi-task machine input worksheet for simulating a multi-task machine as an element of the candidate assembly system layout related to one of the assembly patterns.

9. The method of claim 1, wherein generating a simulation model of a candidate assembly system based upon the candidate assembly system layout further comprises generating a multi-task assembly machine input worksheet for simulating a multi-task assembly machine as an element of the candidate assembly system layout related to one of the assembly patterns.

10. The method of claim 1, wherein generating a simulation model of a candidate assembly system based upon the candidate assembly system layout further comprises generating a buffer worksheet for simulating a buffer as an element of the candidate assembly system layout related to one of the assembly patterns.

11. The method of claim 1, wherein generating a simulation model of a candidate assembly system based upon the candidate assembly system layout further comprises generating a conveyor worksheet for simulating a conveyor as an element of the candidate assembly system layout related to one of the assembly patterns.

12. The method of claim 1, wherein generating a simulation model of a candidate assembly system based upon the candidate assembly system layout further comprises generating a control logic selection worksheet for selecting one of an input or output control logic related to a mechanism for handling part scrapping and machine replenishment as an element of the candidate assembly system layout related to one of the assembly patterns.

13. The method of claim 12, wherein the mechanism for handling part scrapping and machine replenishment comprises a direct replenishment.

14. The method of claim 12, wherein the mechanism for handling part scrapping and machine replenishment comprises a tagged replenishment.

15. A method selecting an assembly system layout for assembling a product, the method comprising:
identifying and evaluating a plurality of candidate assembly system layouts in conjunction with system requirements and constraints; and
selecting one of the candidate system layouts that satisfies an objective function as a preferred assembly system configuration for assembling the product;
wherein identifying candidate assembly system layouts includes generating a plurality of candidate assembly system layouts based upon a desired production volume, a bill of materials, a plurality of assembly patterns, a plurality of permissible machines and associated machine restrictions, and simulating, via a controller, operation of the candidate assembly system layouts to evaluate cycle times and throughput to achieve the assembled product.

16. The method of claim 15, wherein generating each of the plurality of candidate assembly system layouts for the assembled product comprises:
inputting a bill of materials including a list of components for the assembled product;
determining a plurality of assembly patterns for the assembled product including a plurality of intermediate assemblies and sub-assemblies;
determining a basic task layout including assembly tasks for assembling the assembled product based upon a selected one of the assembly patterns;
generating a whole task layout based upon the basic task layout for the selected assembly pattern;
selecting candidate assembly machines for the whole task layout;
identifying zoning constraints for the candidate assembly machines related to assembly tasks;
generating a candidate assembly system layout based upon the whole task layout, the selected candidate assembly machines and the zoning constraints; and
generating a simulation model of a candidate assembly system based upon the candidate assembly system layout.
